(19) United States
(12) Patent Application Publication
(10) Pub. No.: US 2002/0034589 A1
(43) Pub. Date: Mar. 21, 2002

(54) Perfluoroelastomer articles

(76) Inventors: Robert E. Tarney, Hockessin, DE (US); Shuhong Wang, Hockessin, DE (US)

Correspondence Address: DUPONT DOW ELASTOMERS, LLC, LEGAL DEPARTMENT -- PATENTS, 1007 MARKET STREET, WILMINGTON, DE, 19898, US

(21) Appl. No.: 09/928,627

(22) Filed: Aug. 13, 2001

Related U.S. Application Data
(60) Provisional application No. 60/231,024, filed on Sep. 8, 2000.

(51) Int. Cl. B05D 3/02

(52) U.S. Cl. 427/385.5

(57) ABSTRACT

Cured perfluoroelastomer articles are disclosed which have improved surface characteristics. The articles are coated with a thin durable film of thermoplastic fluoropolymer which reduces surface stickiness.

### CROSS-REFERENCE TO RELATED APPLICATIONS

This application claims the benefit of U.S. Provisional Application No. 60/231,024 filed Sept. 8, 2000.

### FIELD OF THE INVENTION

This invention relates to perfluoroelastomer articles having improved surface lubricity. More specifically, this invention relates to perfluoroelastomer articles coated with a thin film of a thermoplastic fluoropolymer.

### BACKGROUND OF THE INVENTION

Perfluoroelastomers have achieved outstanding commercial success and are used in a wide variety of applications in which severe environments are encountered, in particular those end uses where exposure to high temperatures and aggressive chemicals occurs. For example, these polymers are often used in seals for aircraft engines, in oil-well drilling devices, and in sealing elements for industrial equipment used at high temperatures.

The outstanding properties of perfluoroelastomers are largely attributable to the stability and inertness of the copolymerized perfluorinated monomer units that make up the major portion of the polymer backbones in these compositions. Such monomers include tetrafluoroethylene and perfluoro(alkyl vinyl) ethers. In order to develop elastomeric properties fully, perfluoroelastomers are typically crosslinked, i.e. vulcanized. To this end, a small amount of cure site monomer is copolymerized with the perfluorinated monomer units. Cure site monomers containing at least one nitrile group, for example perfluoro-8-cyano-5-methyl-3,6-dioxa-1-octene, are especially preferred. Such compositions are described in U.S. Pat. Nos. 4,281,092; 4,394,489; 5,789,489; and 5,789,509.

In certain end use applications, a cured perfluoroelastomer article may undesirably adhere to the surface of other materials that are in contact with it, particularly if the perfluoroelastomer article and other material are forcibly held in contact for a long period of time at elevated temperatures and then cooled. It may be difficult, or impossible, to easily remove the perfluoroelastomer article from contact with the other material without damaging the perfluoroelastomer article, other material, or both. Thus, there is a need for perfluoroelastomer articles that have an improved, less sticky surface.

Kishino et al. (U.S. Pat. No. 5,763,068) discloses fluororesin-coated fluoroelastomer articles. In contrast to perfluoroelastomers, fluoroelastomers are made from at least one monomer which is either partially fluorinated (such as vinylidene fluoride), or non-fluorinated (such as propylene). The articles are made by first blending uncured fluoroelastomer with up to 50 parts fluororesin; shaping the blend into an article and curing it; coating the cured article with an aqueous fluororesin dispersion; drying the coated article; and finally heating the article above the melting point of the fluororesin in order to form a durable fluororesin film coating. However, blending a high level of fluororesin with a fluoroelastomer or perfluoroelastomer typically reduces the physical properties of cured articles produced from such blends, especially if the articles are used in a high temperature environment. Compression set resistance and elongation are particularly adversely effected. Heating fluoroelastomer articles to a temperature of about 300° C. or higher, in order to melt the fluororesin, may further degrade the physical properties of the articles.

### SUMMARY OF THE INVENTION

An aspect of this invention is a process for manufacturing cured perfluoroelastomer articles which are coated with a durable film of a thermoplastic fluoropolymer. Specifically, this invention is directed to a process comprising:

A. coating a cured perfluoroelastomer article with a thermoplastic fluoropolymer dispersion to produce a wet-coated perfluoroelastomer article, said thermoplastic fluoropolymer having a melting point less than 340° C. and said perfluoroelastomer article containing substantially no thermoplastic fluoropolymer;

B. drying said wet-coated perfluoroelastomer article at a temperature below the melting point of said thermoplastic fluoropolymer to form a dry-coated perfluoroelastomer article; and

C. heating said dry-coated perfluoroelastomer article to a temperature above the melting point of said thermoplastic fluoropolymer for a time sufficient to form a film of thermoplastic fluoropolymer on the surface of said perfluoroelastomer article and for an amount of thermoplastic fluoropolymer to adhere to said perfluoroelastomer article.

Another aspect of this invention is a cured perfluoroelastomer article having a surface coated with a thermoplastic fluoropolymer film as made by the latter process of this invention.

### DETAILED DESCRIPTION OF THE INVENTION

Perfluoroelastomers are polymeric compositions having copolymerized units of at least two principal perfluorinated monomers. Generally, one of the principal comonomers is a perfluoroolefin while the other is a perfluorovinyl ether. Representative perfluorinated olefins include tetrafluoroethylene and hexafluoropropylene. Suitable perfluorinated vinyl ethers are those of the formula

CF₂═CFO(R_{f′}O)ₙ(R_{f″}O)ₘR_{f} (I)

where R_{f′} and R_{f″} are different linear or branched perfluoroalkylene groups of 2-6 carbon atoms, m and n are independently 0-10, and

R_{f} is a perfluoroalkyl group of 1-6 carbon atoms.

A preferred class of perfluoro(alkyl vinyl) ethers includes compositions of the formula

CF₂═CFO(CF₂CFXO)ₙR_{f} (II)

where X is F or CF₃, n is 0-5, and R_{f} is a perfluoroalkyl group of 1-6 carbon atoms.

Most preferred perfluoro(alkyl vinyl) ethers are those wherein n is 0 or 1 and R_{f} contains 1-3 carbon atoms. Examples of such perfluorinated ethers include perfluoro(methyl vinyl) ether and perfluoro(propyl vinyl) ether. Other useful monomers include compounds of the formula

CF₂═CFO[(CF₂)ₘCF₂CFZO]ₙR_{f} (III)

where R_{f} is a perfluoroalkyl group having 1-6 carbon atoms, m=0 or 1, n=0-5, and Z=F or CF₃.

Preferred members of this class are those in which R_{f} is C₃F₇, m=0, and n=1. Additional perfluoro(alkyl vinyl) ether monomers include compounds of the formula

CF₂═CFO[(CF₂CFCF₃O)ₙ(CF₂CF₂CF₂O)ₘ(CF₂)ₚ]CₓF₂ₓ₊₁ (IV)

where m and n=1-10, p=0-3, and x=1-5.

Preferred members of this class include compounds where n=0-1, m=0-1,and x=1.

Examples of useful perfluoro(alkoxy vinyl) ethers include

CF₂═CFOCF₂CF(CF₃)O(CF₂O)ₘCₙF₂ₙ₊₁ (V)

where n=1-5, m=1-3, and where, preferably, n=1.

Mixtures of perfluoro(alkyl vinyl) ethers and perfluoro(alkoxy vinyl) ethers may also be used.

Preferred perfluoroelastomer copolymers are comprised of tetrafluoroethylene and at least one perfluoro(alkyl vinyl) ether as principal monomer units. In such copolymers, the copolymerized perfluorinated ether units constitute from about 15-50 mole percent of total monomer units in the polymer.

The perfluoroelastomer further contains copolymerized units of at least one cure site monomer, generally in amounts of from 0.1-5 mole percent. The range is preferably between 0.3-1.5 mole percent. Although more than one type of cure site monomer may be present, most commonly one cure site monomer is used and it contains at least one nitrile substituent group. Suitable cure site monomers include nitrile-containing fluorinated olefins and nitrile-containing fluorinated vinyl ethers. Useful nitrile-containing cure site monomers include those of the formulas shown below.

CF₂═CF—O(CF₂)ₙ—CN (VI)

where n=2-12, preferably 2-6;

CF₂═CF—O[CF₂—CFCF₃—O]ₙ—CF₂—CFCF₃—CN (VII)

where n=0-4, preferably 0-2; and

CF₂═CF—[OCF₂CFCF₃]ₓ—O—(CF₂)ₙ—CN (VIII)

where x=1-2, and n=1-4.

Those of formula (VIII) are preferred. Especially preferred cure site monomers are perfluorinated polyethers having a nitrile group and a trifluorovinyl ether group. A most preferred cure site monomer is

CF₂═CFOCF₂CF(CF₃)OCF₂CF₂CN (IX)

i.e. perfluoro(8-cyano-5-methyl-3,6-dioxa-1-octene) or 8-CNVE.

Other cure site monomers include olefins represented by the formula R₁CH═CR₂R₃, wherein R₁ and R₂ are independently selected from hydrogen and fluorine and R₃ is independently selected from hydrogen, fluorine, alkyl, and perfluoroalkyl. The perfluoroalkyl group may contain up to about 12 carbon atoms. However, perfluoroalkyl groups of up to 4 carbon atoms are preferred. In addition, the curesite monomer preferably has no more than three hydrogen atoms. Examples of such olefins include ethylene, vinylidene fluoride, vinyl fluoride, trifluoroethylene, 1-hydropentafluoropropene, and 2-hydropentafluoropropene, as well as brominated olefins such as 4-bromo-3,3,4,4-tetrafluorobutene-1 and bromotrifluoroethylene. Alternatively, or in addition to copolymerized units of cure site monomers, cure sites of bromine or iodine-containing end groups may be introduced onto the perfluoroelastomer polymer chain by the reaction of bromine or iodine-containing chain transfer agents during polymerization.

Another type of cure site monomer which may be incorporated in the perfluoroelastomers employed in this invention is perfluoro(2-phenoxypropyl vinyl ether) and related monomers as disclosed in U.S. Pat. No. 3,467,638.

An especially preferred perfluoroelastomer contains 53.0-79.9 mole percent tetrafluoroethylene, 20.0-46.9 mole percent perfluoro(methyl vinyl) ether and 0.4 to 1.5 mole percent nitrile-containing cure site monomer.

When the perfluoroelastomer has copolymerized units of a nitrile-containing cure site monomer, a cure system based on an organotin compound can be utilized. Suitable organotin compounds include allyl-, propargyl-, triphenyl- and allenyl tin curatives. Tetraalkyltin compounds or tetraaryltin compounds are the preferred curing agents for use in conjunction with nitrile-substituted cure sites. The amount of curing agent employed will necessarily depend on the degree of crosslinking desired in the final product as well as the type and concentration of reactive moieties in the perfluoroelastomer. In general, about 0.5-10 parts by weight per 100 parts elastomer (phr) of curing agent can be used, and 1-4 phr is satisfactory for most purposes. It is believed that the nitrile groups trimerize to form s-triazine rings in the presence of curing agents such as organotin, thereby crosslinking the perfluoroelastomer. The crosslinks are thermally stable, even at temperatures of 275° C. and above.

A preferred cure system, useful for perfluoroelastomers containing nitrile-containing cure sites, utilizes bis(aminophenols) and bis(aminothiophenols) of the formulas

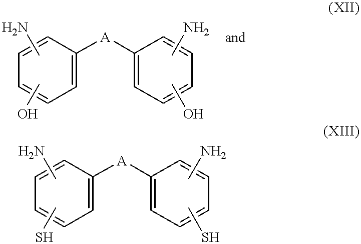

and tetraamines of the formula

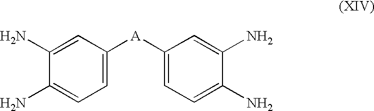

where A is SO₂, O, CO, alkyl of 1-6 carbon atoms, perfluoroalkyl of 1-10 carbon atoms, or a carbon-carbon bond linking the two aromatic rings. The amino and hydroxyl or thio groups in formulas XII and XIII above are adjacent to each other on the benzene rings and are interchangeably in the meta and para positions with respect to the group A. Preferably, the curing agent is a compound selected from the group consisting of 4,4′-[2,2,2-trifluoro-1-(trifluoromethyl)ethylidene]bis(2-aminophenol); 4,4′-sulfonylbis(2-aminophenol); 3,3′-diaminobenzidine; and 3,3′,4,4′-tetraaminobenzophenone. The first of these is the most preferred and will be referred to as bis(aminophenol) AF. The curing agents can be prepared as disclosed in U.S. Pat. No. 3,332,907 to Angelo. Bis(aminophenol) AF can be prepared by nitration of 4,4′-[2,2,2-trifluoro- 1-(trifluoromethyl)ethylidene]-bisphenol (i.e. bisphenol AF), preferably with potassium nitrate and trifluoroacetic acid, followed by catalytic hydrogenation, preferably with ethanol as a solvent and a catalytic amount of palladium on carbon as catalyst. The level of curing agent should be chosen to optimize the desired properties of the vulcanizate. In general, a slight excess of curing agent over the amount required to react with all the cure sites present in the perfluoroelastomer is used. Typically, 0.5-5.0 parts by weight of the curative per 100 parts of elastomer is required. The preferred range is 1.0-2.0 phr.

Peroxides may also be utilized as curing agents, particularly when the cures site is a nitrile group or an iodine or bromine group. Useful peroxides are those which generate free radicals at curing temperatures. A dialkyl peroxide or a bis(dialkyl peroxide) which decomposes at a temperature above 50° C. is especially preferred. In many cases it is preferred to use a ditertiarybutyl peroxide having a tertiary carbon atom attached to peroxy oxygen. Among the most useful peroxides of this type are 2,5-dimethyl-2,5-di(tertiarybutylperoxy)hexyne-3 and 2,5-dimethyl-2,5-di(tertiarybutylperoxy)hexane. Other peroxides can be selected from such compounds as dicumyl peroxide, dibenzoyl peroxide, tertiarybutyl perbenzoate, and di[1,3-dimethyl-3-(t-butylperoxy)butyl]carbonate. Generally, about 1-3 parts of peroxide per 100 parts of perfluoroelastomer is used. Another material which is usually blended with the composition as a part of the peroxide curative system is a coagent composed of a polyunsaturated compound which is capable of cooperating with the peroxide to provide a useful cure. These coagents can be added in an amount equal to 0.1 and 10 parts per 100 parts perfluoroelastomer, preferably between 2-5 phr. The coagent may be one or more of the following compounds: triallyl cyanurate; triallyl isocyanurate; tri(methylallyl)isocyanurate; tris(diallylamine)-s-triazine; triallyl phosphite; N,N-diallyl acrylamide; hexaallyl phosphoramide; N,N,N′,N′-tetraalkyl tetraphthalamide; N,N,N′,N′-tetraallyl malonamide; trivinyl isocyanurate; 2,4,6-trivinyl methyltrisiloxane; and tri(5-norbornene-2-methylene)cyanurate. Particularly useful is triallyl isocyanurate.

Other curatives suitable for vulcanizing perfluoroelastomers having nitrile cure sites include ammonia, the ammonium salts of inorganic or organic acids (e.g. ammonium perfluorooctanoate) as disclosed in U.S. Pat. No. 5,565,512, and compounds (e.g. urea) which decompose to produce ammonia as disclosed in PCT Patent Publication WO 00/09603.

Depending on the cure site monomers present, it is also possible to use a dual cure system. For example, perfluoroelastomers having copolymerized units of nitrile-containing cure site monomers can be cured using a curative comprising a mixture of a peroxide in combination with an organotin curative and a coagent. Generally, 0.3-5 parts of peroxide, 0.3-5 parts of coagent, and 0.1-10 parts of organotin curative are utilized.

Additives, such as fillers (e.g. carbon black and titanium dioxide), stabilizers, plasticizers, lubricants, and processing aids typically utilized in perfluoroelastomer compounding can be incorporated into the compositions of the present invention, provided they have adequate stability for the intended service conditions.

The perfluoroelastomer compositions used in this invention are substantially free of thermoplastic fluoropolymers. By “substantially free”, is meant that the perfluoroelastomer compositions contain less than 5 parts by weight thermoplastic fluoropolymer per 100 parts by weight perfluoroelastomer. By “thermoplastic” is meant fluoropolymers which exhibit a melting point. This is in contrast to fluoroelastomers or perfluoroelastomers which, by definition, are amorphous and do not melt.

Cured perfluoroelastomer articles employed in this invention are made by shaping and then curing the above perfluoroelastomer compositions. Curing may be induced by heat or by radiation. The article may subsequently be post cured at elevated temperatures for a period of time.

Thermoplastic fluoropolymers which may be employed as the coating in this invention are those fluoropolymers which have a melting point less than 340° C., preferably less than 315° C. Such fluoropolymers include, but are not limited to homopolymers of tetrafluoroethylene and copolymers of tetrafluoroethylene which contain up to about 20 mole percent (based on the total moles of monomer units in the copolymer) of a comonomer such as a perfluoro(alkyl vinyl) ether, a fluoroolefin other than tetrafluoroethylene (e.g. hexafluoropropylene) or a hydrocarbon olefin (e.g. ethylene or propylene). Preferably, the tetrafluoroethylene copolymers contain between 1 and 10 mole percent of a comonomer. Specific examples of such fluoropolymers include Krytox® DF lubricant, Teflon® PFA fluoropolymer resin, Teflon® FEP fluoropolymer resin and Tefzel® fluoropolymer resin (all available from DuPont).

In the process of this invention, the thermoplastic fluoropolymer is applied as a dispersion (preferably an aqueous dispersion) to a cured perfluoroelastomer article. Liquids other than water may be used to form the dispersion. The dispersion typically comprises between 10 and 60 weight percent thermoplastic fluoropolymer, based on the total weight of the dispersion. The dispersion may also contain minor amounts of other ingredients such as surfactants, pH buffers, etc.

The cured, perfluoroelastomer article may be coated with thermoplastic fluoropolymer dispersion by any means commonly employed in the art such as by dipping, spray coating, or by contacting with an applicator.

The wet-coated article thus produced is then dried to remove most of the water. Drying may be done at any temperature less than the melting point of the thermoplastic fluoropolymer. Preferably, the drying temperature is between 100° C. and a temperature 10° C. less than the melting point of the thermoplastic fluoropolymer. Care must be taken not to dry the coating too quickly. Otherwise, bubbles may form in the coating, which when burst, may result in large non-coated areas on the surface of the article.

The dry-coated article thus produced is then heated to a temperature above the melting point of the thermoplastic fluoropolymer for a period of time sufficient to form a durable film and to promote adhesion of the film to the perfluoroelastomer article. One skilled in the art will recognize that this period of time will vary depending upon the melting point of the thermoplastic fluoropolymer, the temperature at which the dry coated article is heated, and the thermal stability of the perfluoroelastomer at this temperature. It is not necessary that the resulting film be a continuous film of uniform thickness in order for the resulting perfluoroelastomer article to have a greatly improved surface with little or no stickiness. The physical properties of the film-coated articles of this invention have comparable physical properties to non-coated perfluoroelastomer articles.

To improve the durability (i.e. adhesion) of the thermoplastic fluoropolymer film onto the surface of a cured perfluoroelastomer article, the surface of the article may preferably be pre-treated, i.e. prior to application of the dispersion, to increase surface area. Examples of suitable surface treatments for use in this invention include, but are not limited to roll flow, sanding, grinding, and plasma or chemical etching. Roll flow refers to a process wherein a cured perfluoroelastomer article and abrasive particles (such as rough stones, sand, and Ajax Cleanser (available from Colgate-Palmolive)) are agitated in a container for a period of time in order to increase the surface area of the article via introduction of microscopic pits, cracks and the like onto the surface. Sanding and plasma or chemical etching increases the article's surface area by similar means. Preferably, the surface is also cleaned with an appropriate solvent to remove contaminants such as mold release agents, lubricants, oils, etc.

The thermoplastic fluoropolymer film coated perfluoroelastomer articles of this invention are useful in many end use applications such as those involving high temperatures (i.e. 200° C. or more) and harsh chemical environments wherein it is undesirable for the perfluoroelastomer articles to stick to the surfaces of materials with which the articles are in contact. Examples of such end use applications include semiconductor manufacture and the chemical process industry.

### EXAMPLES

### Test Method

Sticking Force

Stickiness was measured on type 214 o-rings. An o-ring was compressed in a jig between two stainless steel plates. The jig was then placed in an air oven for 16 hours at 160° C. Afterwards, the jig was removed from the oven and allowed to cool at room temperature for 3 hours. The plates were then attached to an Instron and the force required to pull the plates apart was measured.

### Example 1

The cured perfluoroelastomer articles used in this Example were type 214 o-rings made from a perfluoroelastomer comprising copolymerized units of tetrafluoroethylene, perfluoro(methyl vinyl)ether and perfluoro(8-cyano-5-methyl-3,6-dioxa-1-octene). In addition to perfluoroelastomer, o-rings contained 8 phr TiO2 and 16 phr BaSO₄.

O-rings were pretreated to increase their surface area. Treatment was accomplished by placing the o-rings into a cylinder containing coarse rocks, ice and Ajax Cleanser (Colgate-Palmolive). The cylinder was then rolled for 5 to 30 minutes. The surface modified o-rings were then washed in acetone to remove surface contaminants (such as oils and lubricants) prior to coating with fluoropolymer. Some of these surface modified o-rings were used as-is, i.e. without coating, as comparative samples in Sticking Force tests.

Some of the surface modified o-rings were spray coated with an aqueous dispersion containing 15 weight percent Teflon® PFA fluoropolymer resin, dried in air for 30 minutes, and then baked in an air oven at 315° C. for 15 minutes to yield film-coated perfluoroelastomer articles of this invention.

Sticking force of the film-coated perfluoroelastomer o-rings and comparative o-rings was measured according to the Test Method. The results for the coated o-rings of the invention varied from 0 pounds force (0 newtons) to 21 pounds force (93 newtons), depending upon the relative thickness of the fluoropolymer coating. Generally, the thicker the fluoropolymer coating, the less the sticking force. However, thick thermoplastic fluoropolymer coatings may unacceptably reduce the sealing efficiency of the o-rings. Thus, sticking force and sealing efficiency must be balanced for a particular end use application.

The sticking force of the as-is comparative perfluoroelastomer o-rings was measured as 72 pounds force (320 newtons).

What is claimed is:

1. A process for forming a durable thermoplastic fluoropolymer film on a perfluoroelastomer article, said process comprising:
A. coating a cured perfluoroelastomer article with a thermoplastic fluoropolymer dispersion to produce a wet-coated perfluoroelastomer article, said thermoplastic fluoropolymer having a melting point less than 340° C. and said perfluoroelastomer article containing substantially no thermoplastic fluoropolymer;
B. drying said wet-coated perfluoroelastomer article at a temperature below the melting point of said thermoplastic fluoropolymer to form a dry-coated perfluoroelastomer article; and
C. heating said dry-coated perfluoroelastomer article to a temperature above the melting point of said thermoplastic fluoropolymer for a time sufficient to form a film of thermoplastic fluoropolymer on the surface of said perfluoroelastomer article and for an amount of thermoplastic fluoropolymer to adhere to said perfluoroelastomer article.

2. The process of claim 1 further comprising, prior to coating said cured perfluoroelastomer article with said dispersion, surface treating said article in order to produce a surface-modified cured perfluoroelastomer article having increased surface area.

3. The process of claim 1 wherein said thermoplastic fluoropolymer is selected from the group consisting of i) homopolymers of tetrafluoroethylene and ii) copolymers of tetrafluoroethylene with up to 20 mole percent, based on the weight of the copolymer, of a comonomer.

4. The process of claim 3 wherein said comonomer is selected from the group consisting of perfluoro(alkyl vinyl) ethers, hydrocarbon olefins and fluoroolefins other than tetrafluoroethylene.

5. A perfluoroelastomer article coated with a durable thermoplastic fluoropolymer film made by the process according to claim 1.
